(19) United States
(12) Patent Application Publication
(10) Pub. No.: US 2011/0001442 A1
(43) Pub. Date: Jan. 6, 2011

(54) Electric bicycle drive system with regenerative charging

(76) Inventors: Chong Uk Lee, San Diego, CA (US); Paul Chonghoon Lee, Salem, OR (US)

Correspondence Address: Lipsitz & McAllister, LLC, 755 MAIN STREET, MONROE, CT, 06468, US

(21) Appl. No.: 12/459,531

(22) Filed: Jul. 2, 2009

(51) Int. Cl. H02P 5/00; H02J 7/00; H02P 5/685

(52) U.S. Cl. 318/139; 320/117; 318/400.09

(57) ABSTRACT

Methods and apparatus for reconfiguring a battery and/or an electric motor assembly for an electric bicycle drive system are provided. A battery having a plurality of battery cells in a first configuration adapted to provide a first battery voltage can be reconfigured into a second configuration adapted to provide a second battery voltage. The second battery voltage may be lower than the first battery voltage. The battery can be charged when in the second configuration. Similarly, an arrangement of two or more electric motors can be provided in a first configuration adapted to provide at least one of a first torque output during a driving action and a first regenerative voltage output during a braking action. The motors can be reconfigured into a second configuration adapted to provide at least one of a second torque output during the driving action and a second regenerative voltage output during the braking action.

### BACKGROUND OF THE INVENTION

The present invention relates to the field of electric batteries designed for use with electric motors which are rechargeable using regenerative charging, such as batteries for electric bicycles. More specifically, the present invention relates to a reconfigurable battery, reconfigurable electric motors for use with such a reconfigurable battery, and methods for reconfiguring a battery for charging and for reconfiguring electric motors for charging a battery.

The present invention is described in connection with electric bicycles where a rechargeable battery drives an electric motor. In prior art electric bicycles, in some instances the current from the battery is regulated by a speed controller that controls the motor which provides assistance to the rider. In other instances, where the rider wants to slow down or brake going downhill, the motor acts as a generator and supplies the current back to the battery, thereby achieving regenerative braking that recovers part of the energy that would otherwise be lost when using a mechanical brake alone.

An electric motor typically uses a set of magnets, for example, electro magnets and permanent magnets. As the motor turns, the attractive and repulsive forces of these magnets are regulated electrically such that the motor turns continuously in the desired direction. This could be done by electromechanical switches (e.g. commutators), or could be done by solid state switches (e.g. FETs—Field Effects Transistors). FIG. 1 shows an example of a motor 12 connected to a battery 10. As the current Iₘ flows into the motor 12 and the motor turns, the motor generates a back EMF (Electro Motive Force) which is a voltage roughly proportional to the speed of the motor 12. The current Iₘ is defined as (V_{B}−V_{M})/(R_{M}+R_{B}) where R_{M} is the internal resistance of the motor 12 and R_{B} is the internal resistance of the battery. Given a fixed applied voltage V_{B} (e.g. from the battery 10) the back EMF reduces the amount of current that flows into the motor 12, because the current flow is proportional to the difference between the motor voltage V_{M} (back EMF) and the battery voltage V_{B}. For example, if the motor 12 is turning (with some outside assistance) at a rate such that the back EMF equals the battery voltage V_{B}, than there will be no current flow. If the motor 12 turns faster than this such that the back EMF is higher than the battery voltage V_{B}, then the current flows the other way, thereby recharging the battery 10. One extreme case is a stall, when the motor 12 is at rest. The back EMF is zero at rest, and the current flow from the battery 10 is at its maximum, and the motor 12 produces the highest torque.

When the bicycle is moving and the motor 12 produces a finite back EMF, the motor 12 can be used as a generator to recharge the battery 10, while achieving the desired level of braking. In order to achieve this, the voltage out of the motor 12 is increased to a level higher than the battery 10 using a device known as an inverter.

A block diagram of a typical prior art electric bicycle system without regenerative braking is shown in FIG. 2. A battery 10 provides current to a motor 12 though a speed controller 11. The speed controller 11 governs the current flow to the motor 12, thereby controlling its speed. The speed controller 11 may be set to a desired speed by a rider using a control knob 13.

A block diagram of a further prior art electric bicycle system that provides regenerative braking is shown in FIG. 3. FIG. 3 is similar to FIG. 2 but also includes an inverter 14 in parallel with the controller 11 and a switch 15 for switching the motor 12 between controller 11 in a drive mode to the inverter 14 in a braking mode. During the braking mode, current is generated by the motor 12 and passed to the battery 10 by the inverter 14, charging the battery.

It should be noted that a practical system involves two distinct operations, one that drives the motor and the bicycle wheel(s) by supplying current from the battery to the motor(s), and another that uses the current from the motor(s) to charge the battery to achieve regenerative braking, thereby slowing down the bicycle. It should be further apparent from FIG. 3 that in order to recharge the battery, one needs an inverter that increases the voltage from the motor higher than the battery voltage, in order for the current to flow back into the battery.

For a typical rechargeable battery, the charging voltage must be higher than the battery voltage. The higher the charging voltage relative to the battery voltage, the more current flows into the battery. Controlling the charging voltage is one of the ways to control the rate of recharging, as well as the rate of braking. Another way to control the recharging rate is pulse width modulation, where a switch between the charging source and the battery regulates an on-off duty cycle. Of course, the charging voltage still needs to be higher than the battery voltage for such a device to work.

In most electric vehicles such as electric bicycles and electric cars that utilize regenerative braking, the electrical system typically consists of several subsystems, namely a motor, a speed controller, an inverter, and a battery. Sometimes the speed controller regulates both the drive and braking current via PWM (pulse width modulation). Potentially, a clever inverter design could regulate both driving and braking, by regulating the voltage to the motor for driving, and regulating the voltage to the battery for regenerative braking, thereby eliminating the need for a separate speed controller.

However, an inverter is not an easy device to design or cheaply produce, as it must handle a large amount of current (especially during quick braking) and sometimes a high output voltage, while its input voltage can fluctuate over a wide range. The input voltage in this case is the back EMF from the motor, typically close to zero when the bicycle is coming to a stop, and close to the maximum battery voltage when the bicycle is coasting on a level ground at its maximum speed (usually the battery voltage limits the top speed).

Also an inverter typically achieves its functionality using rapid switching devices. One inverter design could turn the DC current from the motor to AC current first, increase the voltage using a step-up transformer, and convert the AC current back to DC in order to recharge the battery. Another inverter design could use temporary energy storage elements such as capacitors and inductors in a charge-pump configuration in order to raise the voltage. The switching frequency involved is typically in the order of 1-100 KHz. In most of the inverter designs, the energy loss is significant, and the cost is very high due to the high current requirement (100 Amps or more) in addition to the weight. For this reason, only a small percentage of the electric bicycle products incorporate regenerative braking in their design.

It would be advantageous to provide a battery and/or electric motor configuration that provides driving and regenerative braking, for example in an electric bicycle, over a reasonable range of operations, but without the need for an inverter.

The methods and apparatus of the present invention provide the foregoing and other advantages.

### SUMMARY OF THE INVENTION

The present invention relates to electric bicycle drive systems. In particular, the present invention relates to a reconfigurable battery and reconfigurable electric motors for use with such a reconfigurable battery in an electric bicycle drive system, and methods for reconfiguring a battery for charging and for reconfiguring electric motors for charging a battery.

In one example embodiment, a method for reconfiguring a battery for charging is provided. The method comprises arranging a plurality of battery cells of a battery in a first configuration adapted to provide a first battery voltage, and reconfiguring at least a portion of the plurality of battery cells into a second configuration adapted to provide a second battery voltage, where the second battery voltage is lower than the first battery voltage. The battery can then be charged when the plurality of cells are arranged in the second configuration.

In the first configuration, the plurality of battery cells may be arranged in series. In the second configuration, the plurality of battery cells may be arranged in parallel.

Alternatively, in the second configuration, a first portion of the plurality of battery cells may be arranged in parallel and a second portion of the battery cells may be arranged in series. In addition, in the second configuration, the plurality of battery cells may be arranged with at least a first portion of the battery cells in series and a second portion of the battery cells in series, with the first portion and the second portion of the battery cells arranged in parallel.

The charging may comprise regenerative charging provided by one or more electric motors during a braking action. In such an example embodiment, the method may also comprise monitoring at least one of the voltage and current of the motor and controlling the reconfiguring of the plurality of battery cells based on the monitoring. In addition, the method may also comprise providing an auxiliary power source for powering means for the monitoring and means for the controlling.

In addition, an amount of braking power required by the braking action may be monitored, and the reconfiguring of the plurality of battery cells may be controlled based on the monitoring. An auxiliary power source may be provided for powering the monitoring means, and for powering the controlling means.

Switching means may be provided, enabling the reconfiguring of the plurality of battery cells. The switching means may be connected to at least one of the battery cells. For example, the switching means may comprise one of pulse width modulation switching means or pulse density modulation switching means.

In one example embodiment, the battery cells may be provided in an electric vehicle and be adapted for regenerative charging. For example, the battery may be provided in one of an electric bicycle, an electric scooter, an electric vehicle, a hybrid vehicle, an electric powered wheelchair, an electric powered golf cart, or the like.

The present invention also includes a method for reconfiguring electric motors. In one example embodiment, such a method may comprise arranging two or more electric motors in a first configuration adapted to provide at least one of a first torque output during a driving action and a first regenerative voltage output during a braking action, and reconfiguring the two or more electric motors into a second configuration adapted to provide at least one of a second torque output during the driving action and a second regenerative voltage output during the braking action.

The first configuration may comprise the two or more electric motors arranged in parallel. The second configuration may comprise the two or more electric motors arranged in series.

In one example embodiment, the method may also comprise providing a battery for operating the two or more electric motors, where the battery may comprise a plurality of battery cells, and selecting one of the first or second configuration of the two or more electric motors for regenerative charging of the battery.

In a further example embodiment, the method may further comprise, providing a battery for operating the two or more electric motors, the battery comprising a plurality of battery cells, and arranging the plurality of battery cells in a first battery configuration adapted to provide a first battery voltage for operating the two or more electric motors during the driving action, and reconfiguring at least a portion of the plurality of battery cells into a second battery configuration adapted to provide a second battery voltage during the braking action, where the second battery voltage is lower than the first battery voltage. The battery can then be charged when the two or more electric motors are arranged in the second configuration and the plurality of cells are arranged in the second battery configuration.

In the first battery configuration, the plurality of battery cells may be arranged in series. In the second battery configuration, the plurality of battery cells may be arranged in parallel.

Alternatively, in the second battery configuration, a first portion of the plurality of battery cells may be arranged in parallel and a second portion of the battery cells may be arranged in series. In addition, in the second battery configuration, the plurality of battery cells may be arranged with at least a first portion of the battery cells in series and a second portion of the battery cells in series, with the first portion and the second portion of the battery cells arranged in parallel.

The method may further comprise monitoring at least one of motor voltage and current of the motors and controlling, based on the monitoring, at least one of the reconfiguring of the plurality of battery cells and the reconfiguring of the two or more electric motors. An auxiliary power source may be provided for powering means for the monitoring and means for the controlling.

In addition, at least one of an amount of braking power required by the braking action and an amount of drive power required by the driving action may be monitored. At least one of the reconfiguring of the plurality of battery cells and the reconfiguring of the two or more electric motors may be controlled based on the monitoring. An auxiliary power source may be provided for powering means for the monitoring and means for the controlling.

Battery cell switching means may be provided enabling the reconfiguring of the plurality of battery cells. The battery cell switching means may be connected to at least one of the battery cells. Motor switching means may be provided enabling the reconfiguring of the two or more electric motors. The motor switching means may be connected to at least one of the electric motors. The battery cell switching means may comprise one of pulse width modulation switching means or pulse density modulation switching means. The motor switching means may comprise one of pulse width modulation switching means or pulse density modulation switching means.

In one example embodiment, two or more electric motors may be provided in an electric vehicle adapted for regenerative braking. For example, the two or more electric motors may be provided in an electric bicycle, an electric scooter, an electric vehicle, a hybrid vehicle, an electric powered wheelchair, an electric golf cart, or the like.

In a further example embodiment of the present invention, each of the two or more electric motors may be configured to provide at least one of a different torque output and a different regenerative voltage output.

The present invention also includes a reconfigurable battery. The reconfigurable battery may comprise a plurality of battery cells of a battery arranged in a first configuration adapted to provide a first battery voltage, and switching means adapted for reconfiguring at least a portion of the plurality of battery cells into a second configuration adapted to provide a second battery voltage. The second battery voltage may be lower than the first battery voltage. Other features discussed above in connection with the methods for reconfiguring a battery for charging may be incorporated into such a reconfigurable battery.

The present invention also includes a reconfigurable electric motor assembly. The reconfigurable motor assembly may comprise two or more electric motors arranged in a first configuration adapted to provide at least one of a first torque output during a driving action and a first regenerative voltage output during a braking action. Switching means may be provided for reconfiguring the two or more electric motors into a second configuration adapted to provide at least one of a second torque output during a driving action and a second regenerative voltage output during a braking action. Other features discussed above in connection with the methods for reconfiguring electric motors may be incorporated into such a reconfigurable electric motor assembly.

### BRIEF DESCRIPTION OF THE DRAWINGS

The present invention will hereinafter be described in conjunction with the appended drawing figures, wherein like reference numerals denote like elements, and:

FIG. 1 shows a conventional electric motor and battery configuration;

FIG. 2 shows a block diagram of a prior art electric bicycle system;

FIG. 3 shows a block diagram of a further prior art electric bicycle system;

FIG. 4 shows an example embodiment of an electric bicycle in accordance with the present invention;

FIG. 5a shows an example embodiment of a reconfigurable battery in a first battery cell configuration in accordance with the present invention;

FIG. 5b shows an example embodiment of a reconfigurable battery in a second battery cell configuration in accordance with the present invention;

FIG. 5c shows an example embodiment of a reconfigurable battery in a further battery cell configuration in accordance with the present invention;

FIG. 6 shows a further example embodiment of a reconfigurable battery in accordance with the present invention;

FIG. 7a shows an example embodiment of a reconfigurable electric motor assembly in a first configuration in accordance with the present invention;

FIG. 7b shows an example embodiment of a reconfigurable electric motor assembly in a second configuration in accordance with the present invention; and

FIG. 8 shows an example embodiment of a reconfigurable electric motor assembly with unequal distribution of load in accordance with the present invention.

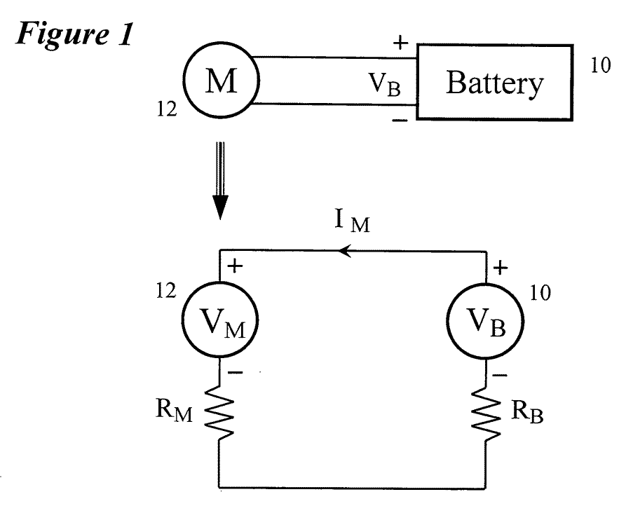

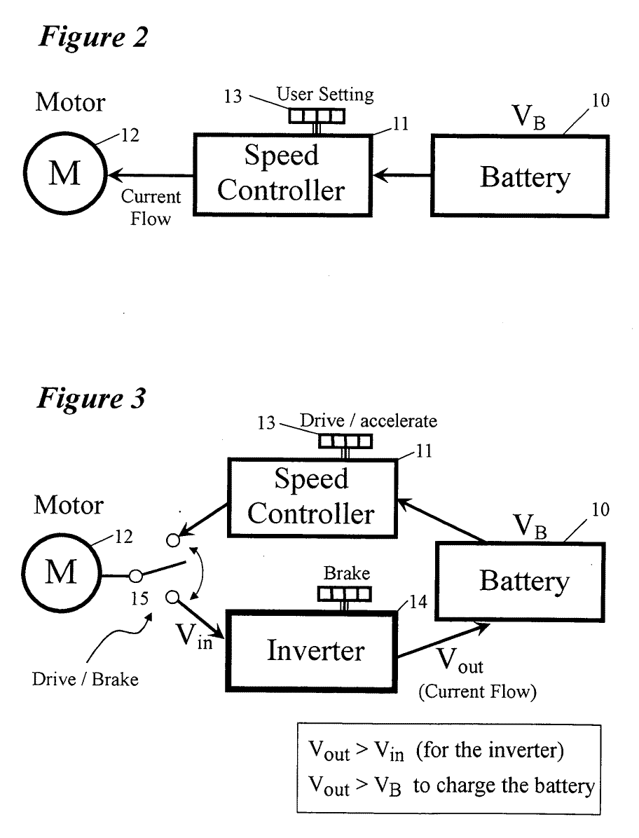

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

Although the present invention is described in connection with electric bicycles where a rechargeable battery drives an electric motor, those skilled in the art will appreciate that it is equally applicable to other types of electric vehicles and battery charging systems.

In many electromechanical system designs (such as an electric bicycle), the complexity of the design problem is managed by breaking the system into separate sub-systems, each providing a specific functionality so that the overall system works well. Each sub-system can be designed more or less independently of the other sub-systems, as long as it meets its given design requirement. A typical prior art electric vehicle design such as an electric bicycle may be divided into the following subsystems: drive train with an electric motor, a speed controller, an inverter, a battery, and perhaps an intelligent central controller that coordinates the other subsystems. As an example, the battery sub-system may typically be supplied by a battery manufacturer with specifications including voltage and current ratings; an inverter designer may work with a specification for a range of possible input voltages from the motor that can be raised high enough to recharge the battery; a mechanical designer would design the drive train and the interface to the motor, and so on, for the other sub-systems. With such an approach, it may be easy to miss system level simplifications or synergies between sub-systems when focusing on one sub-system at a time.

The fundamental problem to be solved when recharging a battery from a motor is to keep the charging voltage higher than the battery voltage. The present invention solves this by effectively lowering the battery voltage during charging periods. This is accomplished in accordance with the present invention by means of a reconfigurable battery. As long as the battery voltage is lower than the voltage generated by the motor, recharging is accomplished. Accordingly, with the present invention, there is no need to raise the voltage out of the motor using an inverter.

A typical battery needed in an electric bicycle must generate 10 s of volts, requiring half a dozen to dozens of battery cells. For example, a typical prior art electric bicycle uses a 36V, 13 Ah NiMH battery. Each battery cell would typically generate between 1.2V (e.g. NiCd or NiMH cells) and 3.6 V (Lilo or LiPo cells). Many of these cells must be connected in series to generate the required voltage for the motor.

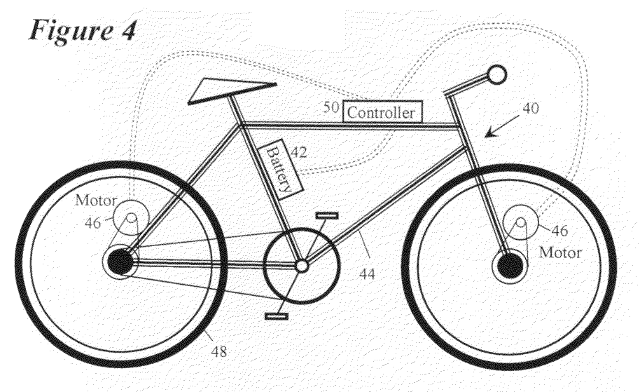

With the present invention, a reconfigurable battery is provided which is adapted to dynamically re-connect and reconfigure the battery cells as the needs of the system change (e.g., from providing current for driving the motor to receiving current for recharging the battery, and vice versa). FIG. 4 shows a simplified embodiment of an electric bicycle 40 in accordance with the present invention. A configurable battery 42 with a plurality of cells is mounted to a bicycle frame 44. At least one motor 46 is mounted on the frame 44 and adapted to drive a wheel 48 of the bicycle 40. The battery 42 and the motor 46 are both in communication with a controller 50. The controller 50 may be adapted to control the current supplied to the motor 46 from the battery 42 for driving the wheel 48, to control the current supplied from the motor 46 to the battery 42 for recharging the battery 42, and for reconfiguring the battery 42 (or reconfiguring a plurality of motors 46) as discussed in detail below.

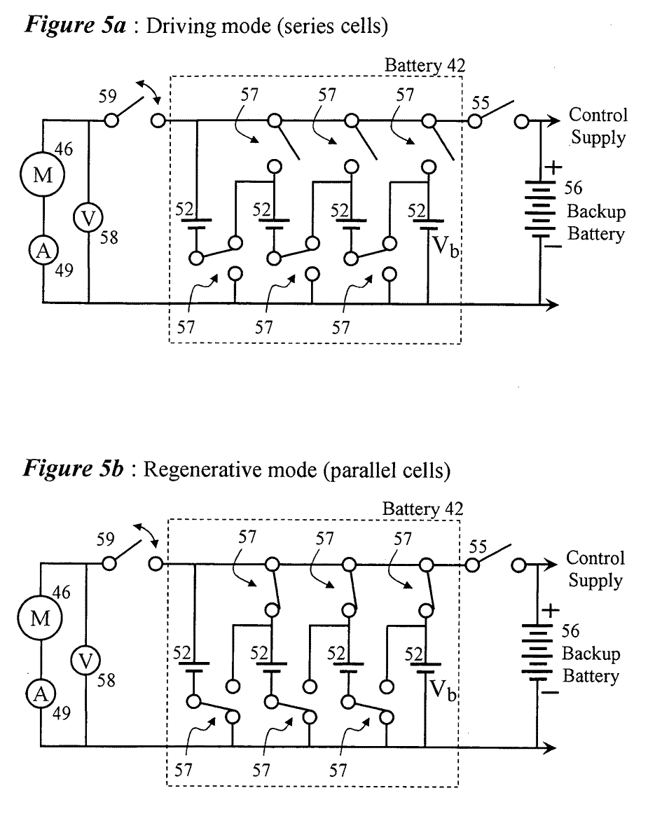

FIGS. 5a and 5b illustrate one example embodiment of a reconfigurable battery in accordance with the present invention. FIG. 5a shows a plurality of battery cells 52 of a battery 42 arranged in a first configuration adapted to provide a first battery voltage to an electric motor 46. FIG. 5b shows the battery cells 52 reconfigured into a second configuration adapted to provide a second battery voltage. It should be appreciated that only a portion of the plurality of battery cells may be reconfigured to provide a second configuration. The second battery voltage may be lower than the first battery voltage. The battery 42 can then be charged when the plurality of cells 52 are arranged in the second configuration.

In the first configuration as shown in FIG. 5a, the plurality of battery cells 52 may be arranged in series. In the second configuration as shown in FIG. 5b, the plurality of battery cells 52 may be arranged in parallel.

Alternatively, in the second configuration, only a first portion of the plurality of battery cells 52 may be arranged in parallel and a second portion of the battery cells 52 may be arranged in series. In addition, in a variation of the second configuration as shown in FIG. 5c, the plurality of battery cells 52 may be arranged with at least a first portion of the battery cells in series and a second portion of the battery cells in series, with the first portion and the second portion of the battery cells arranged in parallel. For example, it is noted that in the examples shown with 4 battery cells 52, the battery 42 can be reconfigured to at least three possible voltages (where Vb is the voltage across each cell 52): 4×Vb (all 4 cells in series as in FIG. 5a), 1×Vb (all 4 cells in parallel as shown in FIG. 5b), and 2×Vb (two pairs of cells in series, with the resulting two pairs arranged in parallel, as shown in FIG. 5c),

The charging may comprise regenerative charging provide by the electric motor(s) 46 during a braking action. In such an example embodiment, at least one of the motor voltage and current of the motor 46 may be monitored. The reconfiguring of the plurality of battery cells 52 may be controlled based on the monitoring. For example, a current sensor 49 could be used to monitor the current through the motor and/or a voltage sensor 58 could be used to monitor the motor voltage, and the sensors 49 and 58 could relay the voltage and/or current information needed to a controller (e.g., controller 50 of FIG. 4) to make a decision on how to reconfigure the battery 42 to the desired battery voltage. Alternatively, a sensor could monitor the motor speed in order to provide equivalent information to the controller 50. In addition, an auxiliary power source (e.g., backup battery 56) may be provided for powering the controller 50 and the sensors 49 and 58.

In addition, an amount of braking power required by the braking action may be monitored and provided to the controller 50, and the reconfiguring of the plurality of battery cells 52 may be controlled based on the monitoring. The applied braking force may be monitored by current sensor 49 (or by the circuitry provided within the electric motor 46 itself), and communicated to the controller 50.

Switching means 57 may be provided, enabling the reconfiguring of the plurality of battery cells. The switching means 57 may be connected to at least one of the battery cells. For example, the switching means 57 may comprise one of pulse width modulation switching means or pulse density modulation switching means controlled by the controller 50.

A speed control switch 59 may also be provided. Switch 59 may be a pulse width modulation switching mechanism and the controller 50 may be a PWM control system adapted to adjust the on-off duty cycle of the PWM switch 59 between the motor 46 and the battery 42. The current sensor 49 may be used to calculate the average amount of current flowing. For example, if the desired amount of current cannot be maintained because the voltage difference between the motor 46 and the battery 42 is too small, the battery 42 may be reconfigured to provide a lower voltage during regenerative charging, or a higher battery voltage for driving or accelerating. For a typical DC motor, the torque of a motor (or the braking force of the motor) is proportional to the current flowing in (or out) of the motor.

The backup battery 56 may or may not be needed, and may be used to run the control circuits and the sensors 49 and 58. This backup battery 56 can be kept charged whenever the motor voltage is higher, with the additional switch 55 controlling the amount of charging.

In one example embodiment, the battery 42 maybe provided in an electric vehicle and be adapted for regenerative charging. For example, the battery 42 may be provided in an electric bicycle (as shown in FIG. 4). Those skilled in the art will appreciate that the reconfigurable battery 42 may be used in other types of electric vehicles, such as an electric scooter, an electric vehicle, a hybrid vehicle, an electric powered wheelchair, an electric powered golf cart, or the like. Also, it should be appreciated that the reconfigurable battery of the present invention may be adapted for use in virtually any type of device that requires the use of rechargeable batteries, in order to reduce the time needed to charge such batteries.

Thus, with the present invention, the battery 42 may be dynamically reconfigured (e.g., via the controller 50) during operation of the system. For example, the controller 50 may configure the battery cells 52 in a series configuration when the electric vehicle is in a drive mode, as shown in FIG. 5a, and may configure the battery cells 52 in a parallel configuration during recharging or regenerative braking, as shown in FIG. 5b.

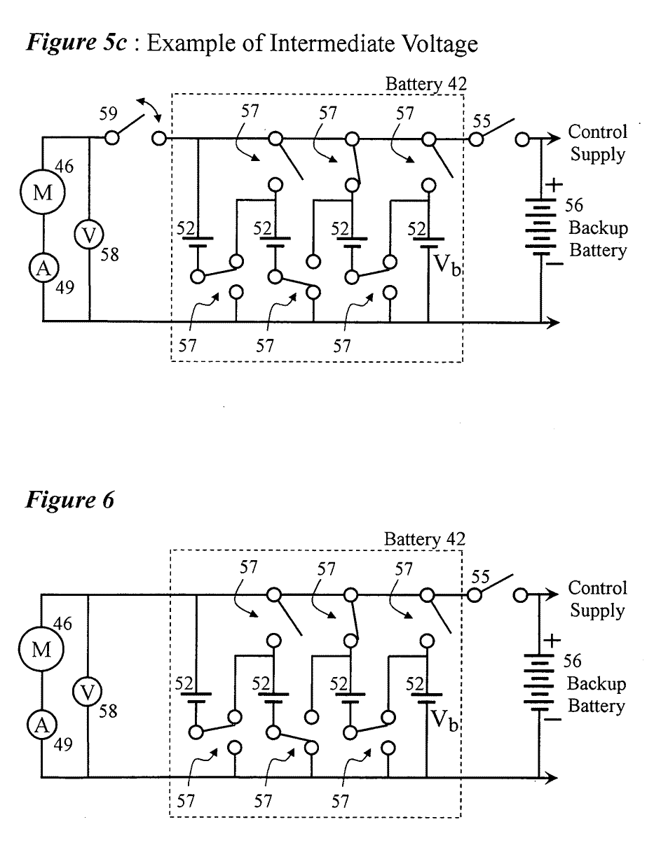

FIG. 6 shows an alternative embodiment where the main PWM switch (switch 59 of FIGS. 5a and 5b) is not needed. In this example embodiment, the reconfiguration switches 57 are controlled in PWM fashion (or alternatively PDM—Pulse Density Modulation).

In some electric bicycle designs, it may be advantageous to use more than one electric motor. For example, one motor may be provided for the front wheel and one motor may be provided for the rear wheel in order to double the drive torque and be able to provide regenerative braking at both wheels. Other possible configurations may call for more motors, possibly two for each wheel. With the present invention, multiple electric motors can be reconfigured to gain certain advantages, similar to reconfiguring of the battery as discussed above. One motivation for reconfiguring an arrangement of electric motors would be to increase or decrease the over-all motor voltage to help regenerative braking, especially at low speeds where each individual motor voltage could be too low to charge even a single battery cell.

Another motivation would be to increase the torque of the motors by arranging the motors in parallel. More current can flow to the aggregate motor(s) (parallel arrangement of motors), as if it is in a “low gear”. If the battery is reconfigured into a parallel arrangement as well, it will be able to supply the higher current the motor demands. Thus, by reconfiguring the arrangement of multiple electric motors as well as the arrangement of multiple battery cells, one may be able to find the optimum combination of series/parallel arrangements for the motors and series/parallel arrangements for the battery cells to accomplish varying situations for the electric vehicle, whether in a drive mode or in a regenerative braking mode.

Accordingly, the present invention also includes methods and apparatus for reconfiguring electric motors, which as discussed below may be combined with the methods and apparatus for reconfiguring a battery.

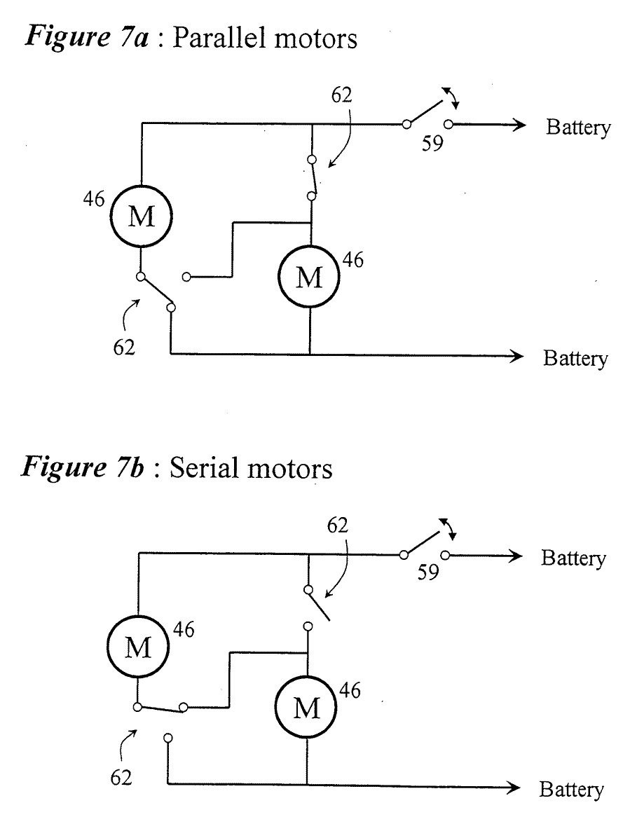

In one example embodiment as shown in FIG. 7a, two or more electric motors 46 are arranged in a first configuration adapted to provide at least one of a first torque output during a driving action and a first regenerative voltage output during a braking action. As shown in FIG. 7b, the two or more electric motors 46 may be reconfigured into a second configuration adapted to provide at least one of a second torque output during the driving action and a second regenerative voltage output during the braking action.

The first configuration as shown in FIG. 7a may comprise the two or more electric motors arranged in parallel. The second configuration as shown in FIG. 7b may comprise the two or more electric motors arranged in series.

In one example embodiment, a battery 42 for operating the two or more electric motors 46 may be provided (e.g., a battery 42 as shown in FIGS. 5a, 5b, 5c, or FIG. 6). The battery 42 may comprise a plurality of battery cells, and one of the first or second configuration of the two or more electric motors 46 may be selected for regenerative charging of the battery 42.

The battery 42 may comprise a plurality of battery cells 52, which may be arranged in a first battery configuration (e.g., as shown in FIG. 5a) adapted to provide a first battery voltage for operating the two or more electric motors 46 during the driving action. At least a portion of the plurality of battery cells 52 may be reconfigured into a second battery configuration (e.g., as shown in FIG. 5b) adapted to provide a second battery voltage during the braking action, where the second battery voltage is lower than the first battery voltage. The battery 42 can then be charged when the two or more electric motors 46 are arranged in the second configuration and the plurality of cells 52 are arranged in the second battery configuration.

In the first battery configuration, the plurality of battery cells 52 may be arranged in series as shown in FIG. 5a. In the second battery configuration, the plurality of battery cells may be arranged in parallel as shown in FIG. 5b.

Alternatively, in the second battery configuration, a first portion of the plurality of battery cells 52 may be arranged in parallel and a second portion of the battery cells 52 may be arranged in series. In addition, in the second battery configuration, the plurality of battery cells 52 may be arranged with at least a first portion of the battery cells 52 in series and a second portion of the battery cells 52 in series, with the first portion and the second portion of the battery cells 52 arranged in parallel (as shown in FIG. 5c).

The voltage (or current) of the motors 46 may be monitored (e.g., via sensors 49 and 58 discussed above in connection with FIGS. 5a and 5b). Based on the monitoring, at least one of the reconfiguring of the plurality of battery cells 52 and the reconfiguring of the two or more electric motors 46 may be controlled (e.g., by controller 50). An auxiliary power source (e.g., backup battery 56) may be provided for powering the controller 50 and the sensors 49 and 58.

In addition, at least one of an amount of braking power required by the braking action and an amount of drive power required by the driving action may be monitored. For example, the applied braking force may be monitored by current sensor 49 (or by the circuitry provided within the electric motor 46 itself), and communicated to the controller 50. At least one of the reconfiguring of the plurality of battery cells 52 and the reconfiguring of the two or more electric motors 46 may be controlled based on the monitoring.

Battery cell switching means 57 may be provided enabling the reconfiguring of the plurality of battery cells 52 (as discussed above). Motor switching means 62 may be provided for enabling the reconfiguring of the two or more electric motors 46. The motor switching means 62 may be connected to at least one of the electric motors 46. The motor switching means 62 may comprise one of pulse width modulation switching means or pulse density modulation switching means.

In one example embodiment, two or more electric motors 46 may be provided in an electric vehicle adapted for regenerative braking. For example, the two or more electric motors 46 may be provided in an electric bicycle, an electric scooter, an electric vehicle, a hybrid vehicle, an electric powered wheelchair, an electric golf cart, or the like.

In embodiments of a reconfigurable battery, a reconfigurable electric motor assembly, or a combination thereof in which a single PWM switch (e.g., switch 59) is used, the controller 50 may be a PWM control system adapted to adjust the on-off duty cycle of the PWM switch between the motor and the battery. The current sensor 49 may be used to calculate the average amount of current flowing. If the desired amount of current cannot be maintained because the voltage difference between the motor 46 and the battery 42 is too small, either the battery 42 or the motor 46 is reconfigured to increase the voltage difference in the right direction (higher motor voltage for regenerative braking, or higher battery voltage for driving or accelerating.)

As discussed above, a speed control switch 59 may also be provided, which may comprise a pulse width modulation switching mechanism. Those skilled in the art will appreciate that an efficient switch is needed to accomplish the electric motor reconfiguration, and that it may also be possible to use multiple FET switches in place of the single PWM switch 59, especially when a parallel motor and a parallel battery combination is needed. It should also be appreciated that the single PWM switch 59 can be replaced by a variable resistance system, as long as the current flow can be regulated. A true variable resistor would dissipate more heat than a PWM switch, but should provide a workable alternative.

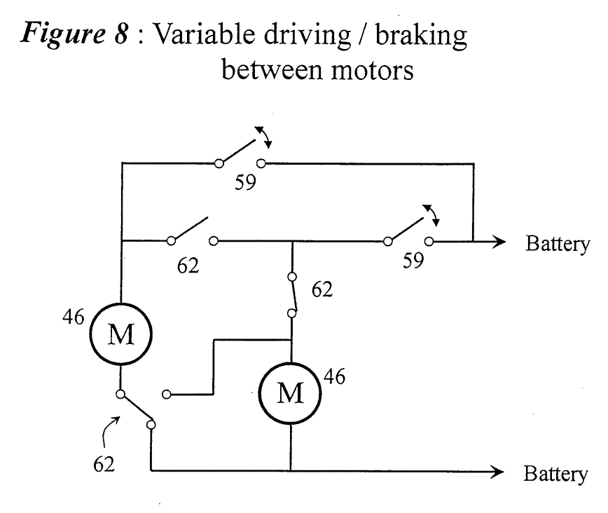

FIG. 8 shows a further example embodiment which provides different drive torque and regenerative braking for each motor 46, using two PWM switches 59 and three motor switching means 62. For example, with the FIG. 8 embodiment, it is possible to apply greater torque from a motor 46 to a rear wheel of an electric bicycle 40 than from a motor 46 to a front wheel of the electric bicycle 40 during acceleration, and to obtain greater regenerative charging from a motor 46 at the front wheel of an electric bicycle than from a motor 46 at a rear wheel of an electric bicycle during braking.

It should be appreciated that measuring the average current flow can take undesirable amount of delay. An alternative is to calculate the current flow expected so that the resistance or the PWM duty cycle can be adjusted in synchrony with the reconfiguration of the battery, the motor, or both.

It should now be appreciated that the present invention provides advantageous methods and apparatus for reconfiguring a battery having a plurality of battery cells, reconfiguring an electric motor assembly, or a combination thereof.

Although the invention has been described in connection with various illustrated embodiments, numerous modifications and adaptations may be made thereto without departing from the spirit and scope of the invention as set forth in the claims.

What is claimed is:

1. A method for reconfiguring a battery for charging, comprising:
arranging a plurality of battery cells of a battery in a first configuration adapted to provide a first battery voltage;
reconfiguring at least a portion of said plurality of battery cells into a second configuration adapted to provide a second battery voltage, said second battery voltage being lower than said first battery voltage;
charging said battery when said plurality of cells are arranged in said second configuration.

2. A method in,accordance with claim 1, wherein in said first configuration said plurality of battery cells are arranged in series.

3. A method in accordance with claim 1, wherein in said second configuration said plurality of battery cells are arranged in parallel.

4. A method in accordance with claim 1, wherein in said second configuration, a first portion of said plurality of battery cells are arranged in parallel and a second portion of said battery cells are arranged in series.

5. A method in accordance with claim 1, wherein in said second configuration said plurality of battery cells are arranged with at least a first portion of said battery cells in series and a second portion of said battery cells in series, with said first portion and said second portion of said battery cells arranged in parallel.

6. A method in accordance with claim 1, wherein said charging comprises regenerative charging provide by an electric motor during a braking action.

7. A method in accordance with claim 6, further comprising:
monitoring at least one of motor voltage and current of said motor; and
controlling said reconfiguring of said plurality of battery cells based on said monitoring.

8. A method in accordance with claim 7, further comprising providing an auxiliary power source for powering means for said monitoring and means for said controlling.

9. A method in accordance with claim 6, further comprising:
monitoring an amount of braking power required by said braking action; and
controlling said reconfiguring of said plurality of battery cells based on said monitoring.

10. A method in accordance with claim 9, further comprising providing an auxiliary power source for powering means for said monitoring and means for said controlling.

11. A method in accordance with claim 1, further comprising providing switching means enabling said reconfiguring of said plurality of battery cells, said switching means being connected to at least one of said battery cells.

12. A method in accordance with claim 11, wherein said switching means comprise one of pulse width modulation switching means or pulse density modulation switching means.

13. A method in accordance with claim 1, wherein said battery cells are provided in an electric vehicle and adapted for regenerative charging.

14. A method in accordance with claim 1, wherein said battery is provided in one of an electric bicycle, an electric scooter, an electric vehicle, a hybrid vehicle, an electric powered wheelchair, and an electric powered golf cart.

15. A method for reconfiguring electric motors, comprising:
arranging two or more electric motors in a first configuration adapted to provide at least one of a first torque output during a driving action and a first regenerative voltage output during a braking action;
reconfiguring said two or more electric motors into a second configuration adapted to provide at least one of a second torque output during said driving action and a second regenerative voltage output during said braking action.

16. A method in accordance with claim 15, wherein said first configuration comprises said two or more electric motors arranged in parallel.

17. A method in accordance with claim 15, wherein said second configuration comprises said two or more electric motors arranged in series.

18. A method in accordance with claim 15, further comprising:
providing a battery for operating the two or more electric motors, said battery comprising a plurality of battery cells; and
selecting one of said first or second configuration of said two or more electric motors for regenerative charging of said battery.

19. A method in accordance with claim 15, further comprising:
providing a battery for operating the two or more electric motors, said battery comprising a plurality of battery cells;
arranging said plurality of battery cells in a first battery configuration adapted to provide a first battery voltage for operating said two or more electric motors during said driving action;
reconfiguring at least a portion of said plurality of battery cells into a second battery configuration adapted to provide a second battery voltage during said braking action, said second battery voltage being lower than said first battery voltage;
charging said battery when said two or more electric motors are arranged in said second configuration and said plurality of cells are arranged in said second battery configuration.

20. A method in accordance with claim 19, wherein in said first battery configuration said plurality of battery cells are arranged in series.

21. A method in accordance with claim 19, wherein in said second battery configuration said plurality of battery cells are arranged in parallel.

22. A method in accordance with claim 19, wherein in said second battery configuration, a first portion of said plurality of battery cells are arranged in parallel and a second portion of said battery cells are arranged in series.

23. A method in accordance with claim 19, wherein in said second battery configuration said battery cells are arranged with at least a first portion of said battery cells in series and a second portion of said battery cells in series, with said first portion and said second portion of said battery cells arranged in parallel.

24. A method in accordance with claim 19, further comprising:
monitoring at least one of motor voltage and current of said motors; and
controlling, based on said monitoring, at least one of said reconfiguring of said plurality of battery cells and said reconfiguring of said two or more electric motors.

25. A method in accordance with claim 24, further comprising providing an auxiliary power source for powering means for said monitoring and means for said controlling.

26. A method in accordance with claim 19, further comprising:
monitoring at least one of an amount of braking power required by said braking action and an amount of drive power required by said driving action; and
controlling, based on said monitoring, at least one of said reconfiguring of said plurality of battery cells and said reconfiguring of said two or more electric motors.

27. A method in accordance with claim 26, further comprising providing an auxiliary power source for powering means for said monitoring and means for said controlling.

28. A method in accordance with claim 19, further comprising providing at least one of:
battery cell switching means enabling said reconfiguring of said plurality of battery cells, said battery cell switching means being connected to at least one of said battery cells; and
motor switching means enabling said reconfiguring of said two or more electric motors, said motor switching means being connected to at least one of said electric motors.

29. A method in accordance with claim 28, wherein:
said battery cell switching means comprise one of pulse width modulation switching means or pulse density modulation switching means; and
said motor switching means comprise one of pulse width modulation switching means or pulse density modulation switching means.

30. A method in accordance with claim 15, wherein said two or more electric motors are provided in an electric vehicle adapted for regenerative braking.

31. A method in accordance with claim 15, wherein said two or more electric motors are provided in an electric bicycle, an electric scooter, an electric vehicle, a hybrid vehicle, an electric powered wheelchair, and an electric golf cart.

32. A method in accordance with claim 15, wherein each of said two or more electric motors are configured to provide at least one of a different torque output and a different regenerative voltage output.

33. A reconfigurable battery, comprising:
a plurality of battery cells of a battery arranged in a first configuration adapted to provide a first battery voltage;
switching means for reconfiguring at least a portion of said plurality of battery cells into a second configuration adapted to provide a second battery voltage, said second battery voltage being lower than said first battery voltage.

34. A reconfigurable electric motor assembly, comprising;
two or more electric motors arranged in a first configuration adapted to provide at least one of a first torque output during a driving action and a first regenerative voltage output during a braking action;
switching means for reconfiguring said two or more electric motors into a second configuration adapted to provide at least one of a second torque output during a driving action and a second regenerative voltage output during a braking action.
